(19) United States
(12) Patent Application Publication
(10) Pub. No.: US 2017/0220365 A1
(43) Pub. Date: Aug. 3, 2017

(54) VIRTUAL MACHINE ALLOCATION TO HOSTS FOR DATA CENTERS

(71) Applicant: International Business Machines Corporation, Armonk, NY (US)

(72) Inventor: Eli M. Dow, Wappingers Falls, NY (US)

(21) Appl. No.: 15/010,318

(22) Filed: Jan. 29, 2016

(51) Int. Cl. G06F 9/455; G06F 9/50

(52) U.S. Cl. CPC G06F 9/45558; G06F 9/5077; G06F 2009/45595; G06F 2009/4557

(57) ABSTRACT

An aspect of the disclosure includes a method, a system and a computer program product for determining allocation of virtual machines to computer servers. The method including generating a list of virtual machines (VMs) instances configured to run on a network. A plurality of equivalence sets of VMs is selected. A plurality of starting sets is generated from the equivalence sets of VMs. Combinations are generated of packing solutions of the equivalent sets to a plurality of computer servers. A resource capacity is determined of a first computer server. A first allocation of the starting sets is provided based on the combinations of packing solutions. A second allocation each VM instance is provided based on a colocation parameter and an anti-colocation parameter. Each VM instance is migrated to one of the computer servers based on the second allocation. The state of a computer server is changed after the migration.

### BACKGROUND

The present invention relates generally to a system and method for operating computer servers in data centers, and in particular to a system and method for allocating virtual machines among the computer servers in the data center.

A contemporary virtual machine (VM) is a software implementation of a machine (i.e., a computer) that executes programs like a physical machine. The VM typically emulates a physical computing environment, but requests for central processing unit (CPU), memory, hard disk, network and other hardware resources are managed by a virtualization layer which translates these requests to the underlying physical hardware. VMs are created within a virtualization layer, such as a hypervisor or a virtualization platform that runs on top of a client or server operating system. The virtualization layer is typically used to create many individual, isolated VMs within a single, physical machine. Multiple VMs are typically used in server consolidation, where different services that were previously run on individual machines are instead run in isolated VMs on the same physical machine.

### SUMMARY

Embodiments include a method, system, and computer program product for determining allocation of virtual machines to computer servers on a network. The method including at least one of generating and accessing a list of virtual machines (VMs) instances configured to run on a network, each VM instance having at least one network resource requirement, each VM instance in the list associated with a size of the at least one network resource requirement. A plurality of equivalence sets of VMs is selected, each VM instance in an equivalence set having a resource requirement size that is at least substantially identical. A plurality of starting sets is generated from the plurality of equivalence set of VMs, each starting set representing all possible combinations of a selected number of individual VM instances from the equivalence set. Combinations are generated of viable packing solutions of the equivalent sets to a plurality of computer servers. A maximum resource capacity is determined of a first computer server of the plurality of computer servers. A first allocation of the starting sets is provided based on the combinations of packing solutions, the first allocation including a group of equivalent sets having a cumulative resource requirement size value that is less than or equal to a maximum resource capacity. A second allocation each VM instance is provided to one of the plurality computer servers based at least in part on a colocation parameter and an anti-colocation parameter. Each VM instance is migrated to one of the plurality of computer servers based on the second allocation. The state of at least one of the plurality of computers is changed after the migration.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing node according to an embodiment of the present invention;

FIG. 2 depicts a cloud computing environment according to an embodiment;

FIG. 3 depicts abstraction model layers according to an embodiment;

FIG. 4 depicts a schematic diagram of a data center that utilizes virtual machines in accordance with some embodiments;

FIG. 5 depicts a flow diagram of a method for allocating virtual machines among the computer servers in the data center;

FIG. 6 depicts a flow diagram of a portion of the method of FIG. 5 for constructing an initial allocation template; and

FIG. 7 depicts a flow diagram of a portion of the method of FIG. 5 for allocating the virtual machines among the computer servers in the data center.

### DETAILED DESCRIPTION

Embodiments of the present disclosure provide for a system and method for allocating or packing instances of virtual machines in a computer network to efficiently use the computer resources in the network. Embodiments provide for allocating of virtual machine instances based on colocation and anti-colocation parameters.

Embodiments described herein are directed to methods, apparatuses and computer program products for modeling virtual machine (VM) allocations and packing or allocating VMs to individual hosts or nodes within, e.g., a server or peer-to-peer computer network. The embodiments described herein are effective for many network applications, such as virtual machine infrastructures including those providing IaaS, PaaS or SaaS cloud hosting.

A persistent challenge to providers of cloud hosting and other network management services is the efficient use of system resources. Efficient allocation of VMs to different network nodes, e.g., network servers, is desired in order to maximize the use of network resources and reduce the number of physical servers and/or physical resources required to provide computing services to customers.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

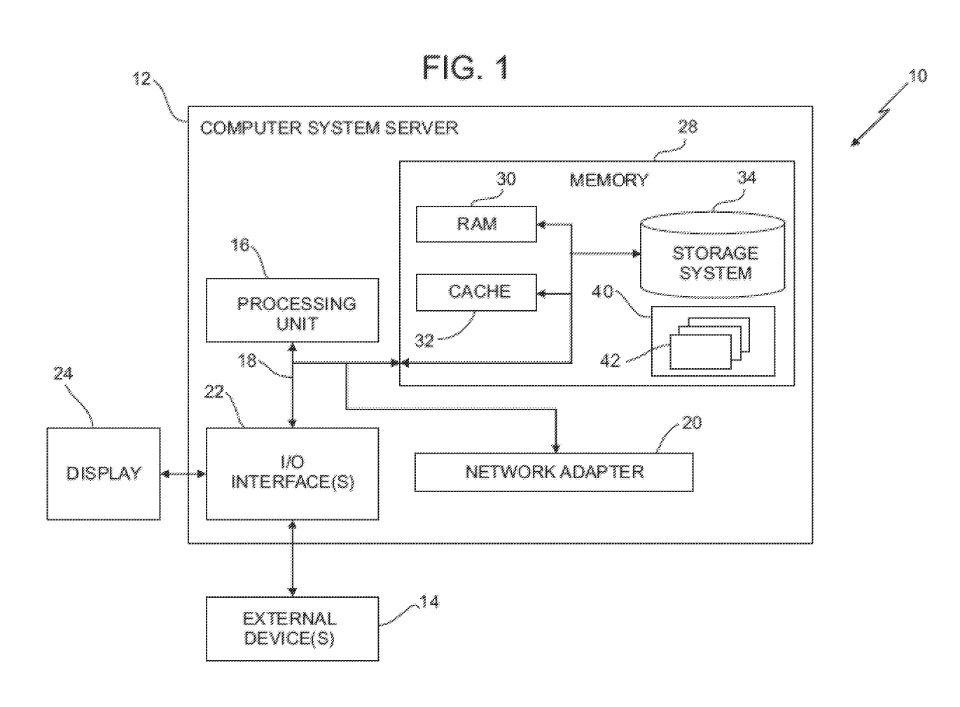

Referring now to FIG. 1, a schematic of an example of a cloud computing node or server is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

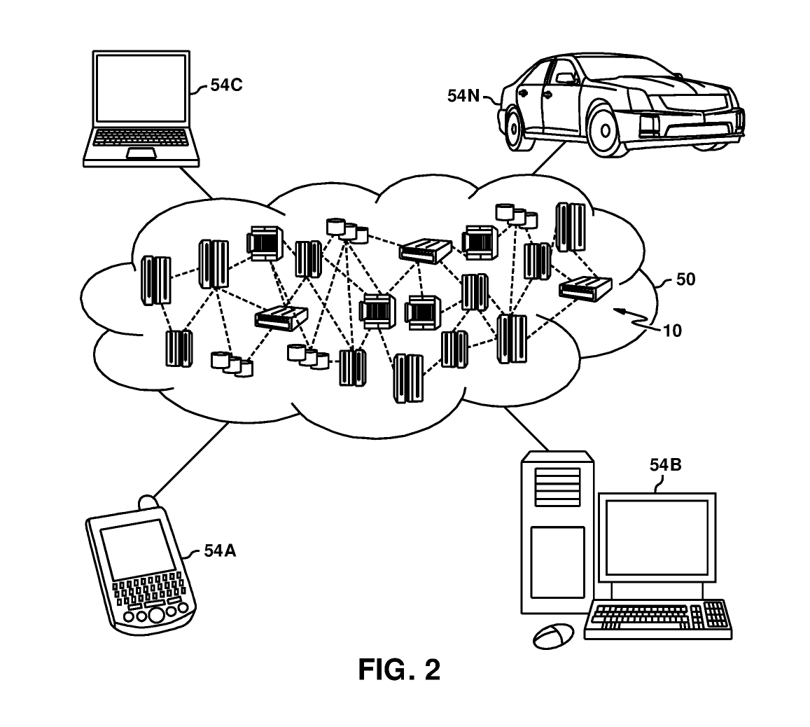

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

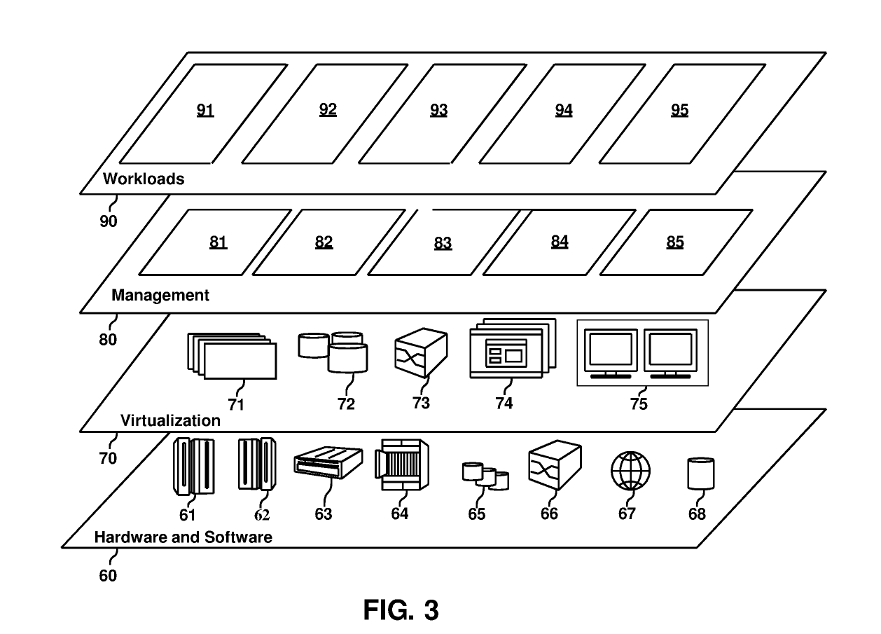

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95.

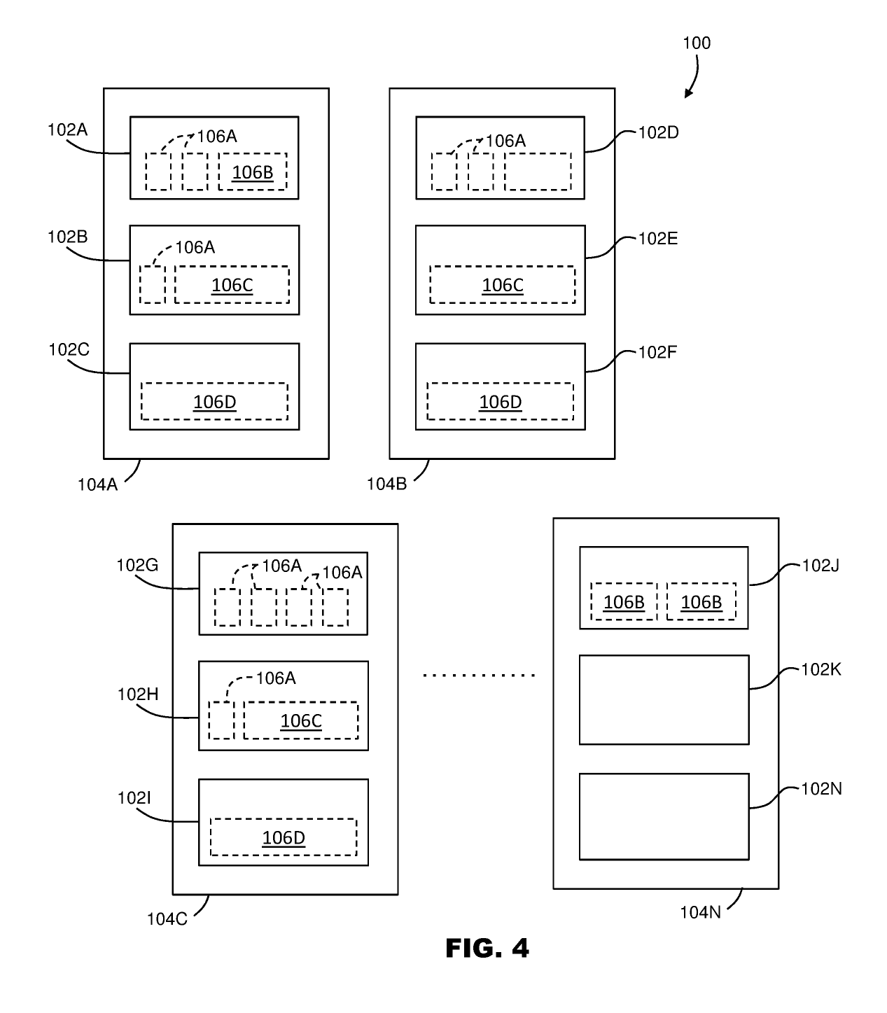

FIG. 4 illustrates any exemplary computing system 100, such as that found in a data center for example, that includes a plurality of servers 102A-102N. In an embodiment, the servers 102A-102N are nodes 10 in the cloud computing environment 50. The servers 102A-102N may be arranged in racks 104A-104N. In exemplary embodiments, each server 102A-102N includes a high-speed processing device including at least one processing circuit (e.g., a CPU) capable of reading and executing instructions, and handling numerous interaction requests from user or client computers as a shared physical resource. Users can initiate various tasks on the servers 102A-102N via the user computers, such as developing and executing system tests, running application programs, and initiating a system migration.

Each of the servers 102A-102N in computer system 100 may be connected to other servers 102A-102N by any type of communications network known in the art. For example, the network may be an intranet, extranet, or an internetwork, such as the Internet, or a combination thereof. The network can include wireless, wired, and/or fiber optic links. It should be appreciated that while in the exemplary embodiment the servers are described as being co-located, this is for exemplary purposes and the claimed invention should not be so limited.

In exemplary embodiments, each servers 102A-102N accesses and stores data in one or more associated data storage devices, which may include any type of storage and may comprise a secondary storage element, e.g., hard disk drive, tape, or a storage subsystem that is internal or external to the node 84. Types of data that may be stored in the source data storage device include, for example, memory included in one or more virtual machine instances (VMs) 106A-106D and allocation and migration data (e.g., data structures). In an exemplary embodiment, VM configuration information and/or node memory access data is also stored in the data storage device. As discussed in more detail herein, the VMs 106A-106D may be categorized into groups where each of the VM instances within the group have an equivalent computational requirement. As will be discussed in more detail herein, in the illustrated embodiment the VMs 106A-106D may be grouped by computational requirement size, such as small VM 106A, medium VM 106B, large VM 106C, and extra-large VM 106D. It should be appreciated that the individual VM instances within a group or equivalence set may be substantially the same or similar, but do not have to be identical. In an embodiment, the computational requirements may include memory (e.g. RAM 30), logical CPU cores (e.g. processing unit 16), network compute units, aggregate network I/O (e.g. I/O interfaces 22), cumulative network read I/O, cumulative network write I/O, colocation rules and anti-colocation constraints. It should further be appreciated that while embodiments herein categorize the VM's into four groups, this is for exemplary purposes and the claimed invention should not be so limited. In other embodiments, the VMs may be categorized into more or less groups provided that the number of groups is finite. In one embodiment, there are seven VM groups (micro, small, medium large, extra-large, 2×-large, and 3×-large).

In exemplary embodiments, the servers 102A-102N executes various applications, such as a node hypervisor and multiple VMs 106A-106D. It should be appreciated that each server 102A-102N may have different computational capabilities and resources (e.g. memory, processor speed, I/O). The computational capabilities of the servers 102A-102N may define the number, type or mixture of VMs 106A-106D that a particular server 102A-102N may support.

As used herein, the term “hypervisor” refers to a low-level application that supports the execution of one or more virtual machines. The hypervisor manages access to resources of the server and serves as a VM monitor to support concurrent execution of the VMs. Each VM can support specific guest operating systems and multiple user sessions for executing software written to target the guest operating systems. For example, one VM may support an instance of the Linux® operating system, while a second VM executes an instance of the z/OS® operating system. Other guest operating systems known in the art can also be supported by the source hypervisor through the VMs.

It should be appreciated that the number of servers 102A-102N operating in the computer system 100 impacts the efficiency of the computer system 100 and the amount of energy consumed. It has been found that on average data centers, such as those that provide Infrastructure-as-a-Service (IaaS) solutions for example, have a server utilization of about 10% (±5%). This low utilization has been found to be inefficient because even idle servers may consume more than 50% of their peak power requirements. Therefore, it is desirable to have fewer servers 102A-102N operating at close to peak utilization to provide a desired efficiency and cost pricing.

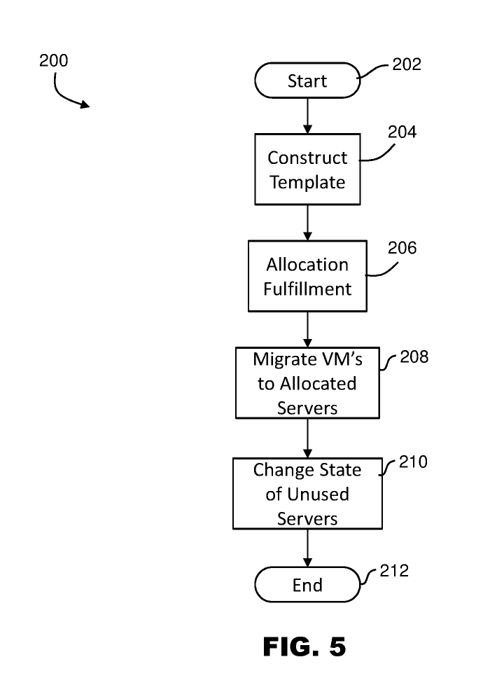

Referring now to FIG. 5, a method 200 is provided to consolidate cloud compute resources, such as VMs 106A-106D onto minimum or reduced number of host servers 102A-102N using a hierarchical multi-objective bin packing process. This process assumes that the computer system 100 provider offers fixed size virtual machines at varying cost structures to customers as an IaaS. As a result, virtual machines belonging to the same capacity and cost structure tier may be considered equivalent for the purposes of packing or allocation assignment. This allows the packing process to be solved as a multi-dimensional bin-packing type of problem where the constraints are related to the host capacities and virtual machine consumption requirements of those capacities, including but not limited to memory, CPU, disk I/O, and networking.

The method 200 beings in block 202 where the consolidation process is initiated. This initiation may be manual, such as by the operator of the computer system 100 for example, or be performed on a periodic or aperiodic basis. In one embodiment, the method 200 is performed on a continuous basis, such that once a preceding execution of the method 200 has been completed, the method 200 starts again in block 202.

Given a server 102A-102N with overall hardware capacity C, the capacity may be represented as a tuple of the individual resources that comprise C, for instance CPU, RAM, and I/O as constituent individual capacities, cᵢ. Thus the capacity of a server 102A-102N may be described as:

C={c₁,c₂,c₃, . . . ,cₙ} s.t. ∀ cᵢ∈ C, cᵢ≧0

where the physical capacities of a limited resource, i.e. c₁, may represent the physical CPU capacity of the server 102A-102N, c₂ represents RAM capacity of the server 102A-102N, and c₃ representing I/O capacity of server 102A-102N with capacity tuple C. It should be appreciated that the RAM or CPU for instance may be decomposed into RAM reads, and RAM writes, likewise I/O operations may be split into constituent read and write I/O operations and treated as such when defining the tuple. In some embodiments, network transmissions and receives may be treated independently, or orthogonally. It should be appreciated by one skilled in the art that the cumulative as well as the individual read (or inbound) or write (or outbound) operations may also be considered with the cumulative measurement yielding three values. The described embodiment uses aggregate values to demonstrate a simple example for clarity and the claimed invention should not be so limited.

A virtual machine, V can similarly be defined as a tuple of resources required for the operation of that VM according to the same resource cardinality used to describe resource capacities of a server 102A-102N. For example:

V={v₁,v₂,v₃, . . . ,vₙ}

The value v₁ represents the CPU requirement of virtual machine V, while v₂ similarly means the RAM requirements of the VM, and v₃ means the I/O requirements of the virtual machine V.

With these attributes defined, a given server 102A-102N may be considered over-constrained if any per-resource cumulative VM utilization exceeds a maximum percentage τ of the physical resource a given threshold. If no oversubscription of resources is allowed with the virtualization platform, (0<τ<=1), if oversubscription of resources is permissible, (0<τ<=τ_{MAX}) where τ_{MAX} is the maximum oversubscription threshold allowed.

There is thus a tuple for defining the per-host (C), per-measured resource utilization/over-constraint percentage (τᵢ) of the form:

τ_{c}={τ₁,τ₂,τ₃, . . . ,τₙ}

Accordingly, each measured resource may have a τ_{MAX} defined according to the same cardinality as C and V that denotes the maximum per-resource utilization/over-constraint percentage for a given measured resource. Functions may be defined to retrieve the over-constraint factor as follows: τ(C,i) which is alternatively written as τ_{c}[i] using array indexing notation, along with and τ_{MAX}(C,i) which is alternatively written as τ_{MAX}c[i], where C remains a specific host instance, and i remains the cardinality of some measured resource.

If there are k virtual machines assigned or allocated to a given host C, the boolean packing allocation P(C) is defined as follows:

$$P ( C ) = \{ \begin{matrix}1 , iff & {\sum }_{i = 1}^{k} {v}_{i} \leq ci * τ ( c , i ) \leq ci * τ MAX ( c , i ) \\ 0 , iff & {\sum }_{i = 1}^{k} {v}_{i} > ci * τ ( c , i )\end{matrix}$$

The general bin packing problem attempts to solve for the minimum number of hosts n, s.t. ∀ Vi ∈ V, Vi is placed on some host Cj ∈ C. Hosts which contain some number of packed VMs form the set C′ with C′⊂C. Any elements in C ∉ C′ are unassigned or unused and the computer system 100 may change the state of the elements C to a powered down or a low power standby state. Thus, in some embodiments it is desirable to use bin packing to determine the smallest n number of servers 102A-102N with one or more VMs allocated, and the allocations are valid according to our packing validity function (P) above.

$$Min ( n ) s . t . \{ \begin{matrix}n = \vert {C}^{′} \vert \\ ∀ Cn ∈ C , V ( C ) = 1\end{matrix}$$

The problem with the general bin packing problem is that it is computationally prohibitive to compute all possible packing solutions to perform this minimization as the combinations of VM to server mappings expands rapidly.

In contrast to previous virtual machine bin packing solutions, the method 200 proceeds to block 204 where a generic solution template is generated to a slightly different problem that relaxes the condition that each VM instance be considered independently or seen as unique in its resource consumption requirements.

In an embodiment it is determined, for each server, the allocation count from a finite (e.g. arbitrarily small) enumeration of similar sized VM instances (e.g. the VM equivalence sets). This arbitrarily small grouping of similar sized VM instances is based on partitioning, or clustering VMs into equivalence sets according to resource consumption size. By relaxing the uniqueness of VM instances and allowing groups of VM instances to be treated identically in terms of assumed, nominal, resource consumption, a solution to this problem can be found very rapidly using a dynamic methodology.

Once this abstract or generic solution for VM allocation is determined, the method 200 proceeds to block 206 where the allocation is fulfilled from the actual list of distinct VM instances being managed by employing a variant of First-Fit Decreasing. As used herein, the First-Fit Decreasing solution considers each of k bins as empty. Beginning with bins k=1 and item i=1, consider all bins j=1, . . . , k and place item i in the first bin that has sufficient residual capacity (i.e., a(i)=j). If there is no such bin available, increment k and repeat until the last item n is assigned.

In block 206, a variant of the First-Fit Decreasing approach is used that selects concrete VM instances from the appropriate size peer-groups using a hierarchical multi-objective methodology. In an embodiment, the methodology may include user-defined parameters, set by the system operator, depending on requirements. These user-defined parameters may include colocation or anti-colocation constraints and limitations for example.

The method 200 then proceeds to block 208 where the VM instances 106A-106D are migrated to their identified servers 102A-102N. In the embodiment illustrated in FIG. 4, after the VM instances 106A-106D are migrated, the servers 102K, 102N no longer have VMs operating. In one embodiment, the state of servers 102K, 102N are changed to a low power operating state or a standby state to reduce the energy consumption (electrical and thermal) in block 210. In one embodiment, the servers 102K, 102N the state is changed to a powered down state and turned off. The method 200 terminates or ends in block 212.

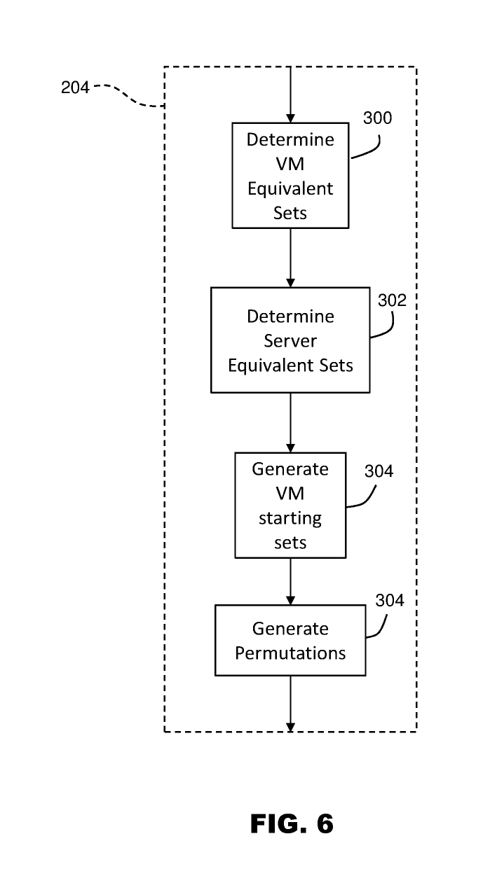

Referring now to FIG. 6, an embodiment is shown of the method 204 for generating a solution template. In an embodiment, the first step in constructing a template for the ideal packing solution is to discretize the virtual machines to be packed into a set of equivalence combinations in block 300. Equivalence here means more or less the same computational requirements. In some situations, the size of equivalence sets combinations are known a priori because virtual machines are cloned from templates, or “golden” master images and then customized for each unique deployment. In an embodiment, the sizes of all containers and all objects to be packed are known prior to running the initiation of method 200.

The equivalence set may be represented by an ordered tuple consisting of the largest, per-VM resource consumption parameters from each element in the set. For example, in experiments the following notation was used to describe an equivalence set: “M::16 C::8 N::2 S::1 E::2” which describes the set of instances containing 16 GB RAM, 8 logical CPU cores, 2 network compute units, a single set holding of 2 concrete elements (VMs) in total. In other embodiments, the network values may be specifically separated out into a cumulative total, as well as constituent read and write capacity. The same methodology may also be implemented for disk I/O for example.

In embodiments where the equivalence sizes are not known prior to initiation of method 200, a clustering approach may be performed to define equivalence groupings, and thereby limit the groupings to a suitably small number of equivalence combinations so as to make this approach computationally viable. Once a cluster is defined using a technique, such as K-means clustering for example, one can define the equivalence set to be each VM in the grouping.

Likewise the servers 102A-120N in the computer system 100 may be partitioned into equivalence sets in block 302. Servers belong to the same equivalence set when any two servers in the set are considered logically equivalent to each other in terms of computational capacity. It should be appreciated that when data center providers procure machines, they are often purchase several servers at a time according to the same specification, thereby lending itself to this approach well. In situations where hosts are not identical machines, servers may be grouped together by system administrators based on servers that have similar compute capabilities.

The method then proceeds to block 304 where starting sets are generated. In an embodiment, the method begins by analyzing each of the virtual machine equivalence combinations and the representative capacity. The method then iteratively generates starting sets representing all possible combinations consisting of only VM instances from the same equivalence set that are viable (would fit logically on the largest server to be filled).

In an embodiment, a limiting factor on the expansion of the starting sets is when the resource requirements grow too large to fit on the largest capacity host. For example, assume the largest capacity host has 1 GB of RAM, and the smallest element from an equivalence set of virtual machines (a set the SMALL instances), each require 256 MB of memory (RAM). In this case the starting sets produced from the SMALL instances would be the following generation: 1×SMALL, 2×SMALL, 3×SMALL, and 4×SMALL as each set would cumulatively require 256, 512, 768, and 1024 MB of memory (RAM), respectively. No larger grouping of SMALL instances would fit on the largest host. These starting sets represent some initial candidate equivalence combinations to consider.

This may also be extended to include an oversubscription parameter for each resource dimension (e.g. memory, CPU, disk I/O, networking I/O, etc.) that allows the resource to be oversubscribed on a per-host basis. From the example above considering no oversubscription for memory (RAM) all 4 of the possible instantiations enumerated may be generated. Each element in the starting set represents an abstract combination from the SMALL-VM set that could be satisfied by concrete VM instances that are considered equivalent.

The generation of abstract combinations may be further limited to ensure that combinations respect each dimension of resource under consideration. For the example above there may actually only be three abstract combinations generated due to the cumulative I/O or CPU requirements of the abstract grouping as compared to the server capacity. The abstract combinations may also be limited to contain no more of an equivalence set than the concrete instances. In other words, something like 4×SMALL is not generated if there are only 3 instances of the small VM size to be packed.

The method proceeds through each VM equivalence set (e.g., MICRO, SMALL, MEDIUM, LG, XL, XXL, QXL) generating all possible combinations of abstract VMs that could reside on the largest server on the network.

This process of creating starting sets, when used with a relatively small number of equivalence sets, completes rapidly. The number of starting sets is on the order of the number of virtual machine categories (equivalence sets provided as input).

With the completion of the generation of abstract starting sets, the method proceeds to block 304 where combinations of abstract, but viable, packing solutions are generated. Expansion proceeds as follows according to a dynamic programming regime. First it is assumed that labels a, b, c, and dare labels for each of the generated equivalence sets (from block 304). At step 1 the table of combinations could be listed as follows with a row dedicated to each known set where a<b<c<d where the < operator is a standardized comparator, such as memory (RAM) consumption for example:
a
b
c
d

At the next iteration, each row is combined with all elements below it:
a, ab, ac, ad
b, bc, bd
c, cd
d

Continuing in this fashion on a second iteration:
a, ab, ac, ad, abc, abd, acd
b, bc, bd, bcd
c, cd
d

And the final iteration yields the complete combination list:
a, ab, ac, ad, abc, abd, acd, abcd
b, bc, bd, bcd
c, cd
d

As expected 15 values are generated from the original 4. This is because the combinations of C(4,4)+C(4,3)+C(4,2)+C(4,1) follow the standard C(x, y) meaning “combinations of x values by choosing y elements.” It should be appreciated that virtual machine packing is a combination problem not a permutation problem since order does not matter (e.g. a set consisting of a small VM and a medium VM is the same as a medium VM and a small VM), and repeats are not possible.

In operation single elements do not start on each starting row. However the starting sets expanded from the singleton abstract VMs. Each of the starting sets' elements are combined with every element not from its own starting set modulo invalid combinations. Invalid combinations limit the state expansion due to the limitation that candidate combinations remain dimensionally smaller than the largest server (note that smaller here means that the candidate solution combination is constrained by each compute resource dimension being observed).

By sorting the list of candidate solution recipes hierarchically as they are generated (for instance by cumulative memory requirement, then by cumulative CPU capacity required, etc.) the state expansion in computing all possible combinations may be reduced through short circuit evaluation. The general worst-case runtime of computing bin-packing solutions, via a computation of VM to host mapping possibilities is shown in Equation 1:

O(n²) (1)

Where n is the number of VMs and k is the number of host servers. Instead we compute something with complexity:

$$O ( {\sum }_{i = 0}^{n} \frac{n !}{( n - i ) !} ) ) \qquad ( 2 )$$

In Equation 2, the runtime of combination is determined based on virtual machine placement equivalence. In Equation 2, n is the size of the set of equivalence combinations, and i is simply the counter from 1 to n. In another embodiment we could consider that this approach runs in time:

O(n^{k}) (3)

Equation 3 is an example of a second formulation of the runtime of combination computation based on virtual machine placement equivalence. In Equation 3, the value of n is once more the size of the set of equivalence combinations. Since it is known that n is a much smaller value than the n from Equation 1, the base improvement shows a potential for speedup assuming k is greater than or equal to 2. Considering that the exponent term in Equation 3 is a constant value of 2 rather than the size of the number of servers as compared to the exponent in Equation 1, this comparison of exponential terms suggests a large speedup in computation time for the abstract solution as compared to the exhaustive concrete solution for all situations where the data center has more than 2 servers. The resulting implication is that the ability to compute the general form of a VM packing solution, if not the exact solution in light of equivalence partitions among the virtual machines is a reasonable strategy to pursue to achieve a solution in a reasonable time period.

It should be appreciated that the approach of generating the candidate recipe of what the ideal VM allocation to host mapping solution should look like in the abstract is substantially faster than computing all possible concrete combinations of virtual machine assignments. Further, at this point, when abstract solution generation is completed a partial solution to the VM consolidation problem is provided shows what the ideal consolidation should look like in the abstract (e.g., 2×SMALL, 3×MEDIUM, 1×XL).

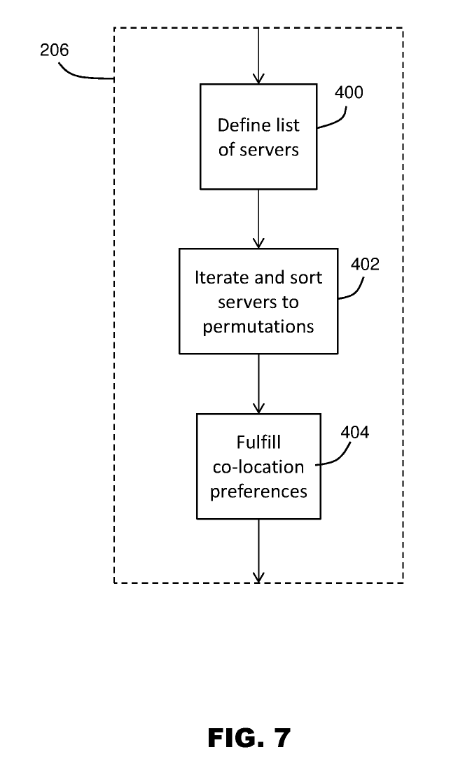

Referring now to FIG. 7, an embodiment is shown of a method of assigning or allocating VM instances 106A-106D to the respective servers 102A-102N. The method begins by iterating through the list of hardware servers in block 400. The list of hardware servers is sorted in largest to smallest computing capacity. As discussed herein, the servers 102A-102N may not all have identical computing capacity.

Iterations are performed on the sorted list of largest to smallest equivalence set combinations in block 402 by assigning the first combination that is satisfiable by the remaining, unassigned concrete VM instances. As such, this method is similar to the First-Fit Decreasing method, except that the servers with the maximum or “largest” computing capacity are filled first, with the “largest” equivalent set suitable for operation on that server.

Once an equivalence set is found that fits the server being filled, the satisfier tries to locate concrete VM instances according to that equivalence set specification. If the set is not satisfiable (i.e., the equivalence set selected indicated 3 large VMs and there are only 2 remaining) the candidate set is removed from the list, and the method advances to the next “largest” candidate equivalence set. It should be appreciated that in this context, the term “largest” means the biggest according to a multi-objective comparator function used to sort the lists prior to satisfaction time.

In the assignment phase of consolidation, we have a roadmap for what the consolidation should look like. In other words, the size VM 106A-106D that should be assigned to a particular server 102A-102N has been identified, but not the specific or particular VM instance that is representative of the assignment plan. While any VM instance from the equivalence set specification (i.e., any SMALL VM is as good as any other) may be assigned arbitrarily, this may lead to less than desired results. In the exemplary embodiment, the method proceeds to block 404 where the assignment of a particular VM instance to a particular server is based at least in part on colocation and anti-colocation parameters associated with each VM instance. As used herein, a colocation parameter is a rule, constraint or limitation, such as one defined by a contract or agreement between the computer system 100 provider and their customer for example, that requires or prefers to have some VM instances operated on the same server. As used herein, an anti-colocation parameter is a rule, constraint or limitation, such as defined by contract or agreement between the computer system 100 provider and their customer, which requires some VM instances be operated on separate servers from other (or specific) VM instances. Colocation and anti-colocation preferences are sometimes referred to as “hard” (e.g. the computer system provide must be fulfill the preference) or “soft” (e.g. the computer system provider should try to fulfill the preference).

For example, when selecting VM instances a per-VM index of preferential colocation candidates and a per-VM set of anti-colocation constraints may be used at satisfaction/allocation time. Anti-colocation preferences are resolved first as they may be considered a hard requirement. In some embodiments, colocation, or affinity preferences, may be considered optional (e.g. “soft”) and satisfied when possible given the other firm constraints. It should be appreciated that colocation preferences may also be a hard requirement. In one embodiment, load balancing may be used across the consolidated hypervisors by using the actual runtime resource consumption of each VM rather than just the nominal resource consumption maximums attributed to the equivalence group to which the VM instance belongs.

A simulation of the method 200 was performed on an IBM® Blade Center server, with 24-core CPUs and 94 GB RAM and on a Macbook® Pro laptop computer with 16 GB RAM. This simulation included a group of 79 VM instances that were distributed among 7 equivalence sets. This simulation resulted in the generation 4,375,850 valid assignment combinations during block 204 which took 8 seconds of time. The sorting and assignment in block 206 was performed in 14 seconds to arrive at the final allocation of VMs to servers. A second simulation was performed using 7850 VMs arranged into seven equivalence sets. This resulted in 13,465,212 combinations being generated in about 28 seconds. The sorting and assignment was performed in sixty seconds. It should be appreciated that this rapid allotment of VMs may allow for packing of the VMs on a regular basis by the computer system 100 to improve efficiency.

It should further be appreciated that regular packing of the VM instances on a periodic, aperiodic or continuous basis may provide for reductions in power consumption by the computer system 100. The relationship between CPU usage and server power consumption has been described as a linear relationship between power consumption of the server and the increase of CPU utilization. The range of this covariance extends from virtually idle through fully utilized states.

P(u)=P_{idle}+(P_{busy}−P_{idle})*u (4)

Equation 4 shows a linear model of power estimation based on CPU and idle power consumption. In Equation 4, P is the estimated power consumption, while P_{idle} is the power consumption of an idle server, and with P_{busy} as the power consumption of a fully utilized server. The value u is the instantaneous present CPU utilization of the host. Using Equation 4, the future power consumption of a server can be estimated with error below 5%.

Empirical, nonlinear, models have also been proposed, such as:

P(U)=P_{idle}+(P_{busy}−P_{idle})(2U−u^{r}) (5)

Equation 5 shows an improved empirical model of power estimation based on calibration experimentation. In Equation 5, the parameter r is an experimentally obtained calibration parameter that minimizes the square error for the given class of server hardware. To utilize this formula, each class of server hardware must undergo a set of calibration experiments to generate the value of r that tunes the model. Using this method, the demonstrated prediction error is below 1% for a tuned empirical model.

Thus, it is contemplated that servers may be treated as equivalent resources in the same fashion as virtual machines are considered equivalent. This method is contemplated as making the assumption that the “smallest” hardware resource capacity vector may be used from a set of servers that have been arbitrarily clustered, perhaps through K-means or similar clustering approaches) by their power consumption estimation (Equation 4 or Equation 5).

Technical effects and benefits of some embodiments include providing a system and method for packing VM instances on servers in a computer system to reduce energy consumption by the computer system.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for determining allocation of virtual machines to a plurality of computer servers, comprising:
identifying a plurality of virtual machine (VM) instances configured to run on a network, each VM instance being associated with a respective network resource size requirement;
determining a plurality of VM equivalence sets of VMs, each VM equivalence set comprising a respective subset of the plurality of VM instances, the respective network resource size requirement associated with each VM instance in the respective subset being at least substantially identical;
partitioning the plurality of computer servers into a plurality of server equivalence sets, each server equivalence set comprising a respective subset of the plurality of servers, each server in a same server equivalence set having a logically equivalent computational capacity;
generating a plurality of starting sets from the plurality of VM equivalence sets, each starting set representing all possible combinations of a selected number of individual VM instances from a corresponding VM equivalence set;
generating packing solution combinations of the plurality of VM equivalence sets for the plurality of computer servers, wherein each of the packing solution combinations comprises only a respective set of concrete VM instances, and wherein the plurality of VM instances comprises each respective set of concrete VM instances;
determining a maximum resource capacity of a first computer server of the plurality of computer servers;
determining a first packing solution combination having a cumulative resource requirement size value that is less than or equal to the maximum resource capacity of the first computer server;
selecting a first subset of the plurality of VM instances that corresponds to the first packing solution combination, wherein each VM instance in the first subset corresponds to a respective VM equivalence set, and wherein at least two VM instances in the first subset are selected based at least in part on at least one of a colocation parameter or an anti-colocation parameter;
allocating the first subset of the plurality of VM instances to the first computer server, wherein allocating the first subset comprises migrating at least one VM instance in the first subset from a second computer server of the plurality of computer servers; and
changing a state of the second computer server after the migration.

2. The method of claim 1, wherein determining the plurality of VM equivalence sets includes determining a first VM equivalence set comprising a first respective subset of VM instances associated with a first network resource size requirement and a second VM equivalence set comprising a second respective subset of VM instances associated with a second network resource requirement that is different than the first network resource size requirement.

3. The method of claim 2, further comprising sorting the plurality of server equivalence sets based on the logically equivalent computing capacity prior to allocating the first subset of the plurality of VM instances.

4. The method of claim 1, wherein determining the first packing solution combination comprises iterating on a sorted list of a largest packing solution combination to a smallest packing solution combination.

5. The method of claim 4, wherein the first packing solution combination is the largest packing solution combination and the first computer server has a largest computing capacity of the plurality of computer servers.

6. The method of claim 1, wherein allocating the first subset of the plurality of VM instances is further based on load balancing using an actual runtime resource consumption for each VM instance in the first subset.

7. The method of claim 1, wherein the colocation parameter is a hard colocation parameter that is satisfied by allocating the first subset of the plurality of VM instances to the first computer server.

8. A system for determining allocation of virtual machines to a plurality of computer servers, comprising:
at least one processing device disposed in at least computing device coupled to a network; and
a storage device having instructions stored thereon that, when executed by the at least one processing device, cause the system to:
identify a plurality of virtual machine (VM) instances configured to run on the network, each VM instance being associated with a respective network resource size requirement;
determine a plurality of VM equivalence sets of VMs, each VM equivalence set comprising a respective subset of the plurality of VM instances, the respective network resource size requirement associated with each VM instance in the respective subset being at least substantially identical;
partition the plurality of computer servers into a plurality of server equivalence sets, each server equivalence set comprising a respective subset of the plurality of servers, each server in a same server equivalence set having a logically equivalent computational capacity;
generate a plurality of starting sets from the plurality of VM equivalence sets, each starting set representing all possible combinations of a selected number of individual VM instances from a corresponding equivalence set;
generate packing solution combinations of the plurality of VM equivalence sets for the plurality of computer servers, wherein each of the packing solution combinations comprises only a respective set of concrete VM instances, and wherein the plurality of VM instances comprises each respective set of concrete VM instances;
determine a maximum resource capacity of a first computer server of the plurality of computer servers;
determine a first packing solution combination having a cumulative resource requirement size value that is less than or equal to the maximum resource capacity of the first computer server;
select a first subset of the plurality of VM instances that corresponds to the first packing solution combination, wherein each VM instance in the first subset corresponds to a respective VM equivalence set, and wherein at least two VM instances in the first subset are selected based at least in part on at least one of a colocation parameter or an anti-colocation parameter;
allocate the first subset of the plurality of VM instances to the first computer server, wherein allocating the first subset comprises migrating at least one VM instance in the first subset from a second computer server of the plurality of computer servers; and
change a state of the second computer server after the migration.

9. The system of claim 8, wherein determining the plurality of VM equivalence sets includes determining a first VM equivalence set comprising a first respective subset of VM instances associated with a first network resource size requirement and a second VM equivalence set comprising a second respective subset of VM instances associated with a second network resource size requirement that is different than the first network resource size requirement.

10. The system of claim 9 wherein the instructions, when executed by the at least one processing device, further cause the system to sort the plurality of server equivalence sets based on the logically equivalent computing capacity prior to allocating the first sub set of the plurality of VM instances.

11. The system of claim 8, wherein determining the first packing solution combination comprises iterating on a sorted list of a largest packing solution combination to a smallest packing solution combination.

12. The system of claim 11, wherein the first packing solution combination is the largest packing solution combination and the first computer server has a largest computing capacity of the plurality of computer servers.

13. The system of claim 8, wherein allocating the first subset of the plurality of VM instances is further based on load balancing using an actual runtime resource consumption for each VM instance in the first subset.

14. The system of claim 8, wherein the colocation parameter is a hard colocation parameter that is satisfied by allocating the first subset of the plurality of VM instances to the first computer server.

15. A computer program product for determining allocation of virtual machines to a plurality of computer servers on a network, the computer program product comprising a computer readable storage medium having program code embodied therewith, the program code readable/executable by a processor to perform a method comprising:
identifying a plurality of virtual machine (VM) instances configured to run on the network, each VM instance being associated with a respective network resource size requirement;
determining a plurality of VM equivalence sets of VMs, each VM equivalence set comprising a respective subset of the plurality of VM instances, the respective network resource size requirement associated with each VM instance in the respective subset being at least substantially identical;
partitioning a plurality of computer servers into a plurality of server equivalence sets, each server equivalence set comprising a respective subset of the plurality of servers, each server in a same server equivalence set having a logically equivalent computational capacity;
generating a plurality of starting sets from the plurality of VM equivalence sets, each starting set representing all possible combinations of a selected number of individual VM instances from a corresponding VM equivalence set;
generating packing solution combinations of the plurality of VM equivalence sets from the plurality of computer servers, wherein each of the packing solution combinations comprises only a respective set of concrete VM instances, and wherein the plurality of VM instances comprises each respective set of concrete VM instances;
determining a maximum resource capacity of a first computer server of the plurality of computer servers;
determining a first packing solution combination having a cumulative resource requirement size value that is less than or equal to the maximum resource capacity of the first computer server;
selecting a first subset of the plurality of VM instances that corresponds to the first packing solution combination, wherein each VM instance in the first subset corresponds to a respective VM equivalence set, and wherein at least two VM instances in the first subset are selected based at least in part on at least one of a colocation parameter or an anti-colocation parameter;
allocating the first subset of the plurality of VM instances to the first computer server, wherein allocating the first subset comprises migrating at least one VM instance in the first subset from a second computer server of the plurality of computer servers; and
changing a state of the second computer server after the migration.

16. The computer program product of claim 15, wherein determining the plurality of VM equivalence sets includes determining a first VM equivalence set comprising a first respective subset of VM instances associated with a first network resource size requirement and a second VM equivalence set comprising a second respective subset of VM instances associated with a second network resource requirement that is different than the first network resource size requirement.

17. The computer program product of claim 16, the method further comprising sorting the plurality of server equivalence sets based on the logically equivalent computing capacity prior to allocating the first subset of the plurality of VM instances.

18. The computer program product of claim 15, wherein determining the first packing solution combination comprises iterating on a sorted list of a largest packing solution combination to a smallest packing solution combination, and the first packing solution combination is the largest packing solution combination and the first computer server has a largest computing capacity of the plurality of computer servers.

19. The computer program product of claim 15, wherein allocating the first subset of the plurality of VM instances is further based on load balancing using an actual runtime resource consumption for each VM instance in the first subset.

20. (canceled)

21. The method of claim 1, wherein the first computer server and the second computer server are included in a same server equivalence set.
